(19) United States
(12) Patent Application Publication
(10) Pub. No.: US 2005/0240407 A1
(43) Pub. Date: Oct. 27, 2005

(54) Method and system for presenting content to an audience

(76) Inventors: Steven John Simske, Fort Collins, CO (US); Robert Eugene Chalstrom, Fort Collins, CO (US); Xiaofan Lin, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/829,519

(22) Filed: Apr. 22, 2004

(51) Int. Cl. G10L 17/00

(52) U.S. Cl. 704/246

(57) ABSTRACT

A method for presenting content to an audience includes the steps of receiving a voice input from an audience member, determining the identity of the audience member, converting the voice input from the identified audience member to text, and presenting the text to the audience. A system that brings about the method is also described.

### BACKGROUND OF THE INVENTION

In modern business environments, presentations that cover even the most interesting subject matter can often be presented in a manner that appears dry and uninteresting to the audience. This can be especially true when the audience feels disengaged from the presenter and has little or no control over the content or flow of the subject matter being presented. In these instances, the presenter may appear to drone on and on with his or her monologue while the audience drifts off, paying less and less attention to the presentation as time goes on. This represents a significant waste of time and resources for both the audience as well as the presenter.

When audience members are free to ask questions of the presenter, a more lively discussion can result. However, especially when larger audiences are present, it is not always easy for all of the audience members to hear the questions being asked of the presenter. Thus, the ability to interact can make the presentation livelier for some audience members, but it does not benefit those audience members who cannot hear the questions, as even the most credible answers are meaningless without having heard the questions. This problem can be partially solved by placing microphones at strategic locations around the room; however, this requires some audience members to wait in line while other audience members monopolize the microphones.

At other times, multiple audience members may try to simultaneously speak, especially during more controversial portions of the presentation. The resulting unintelligible stream of voices can preclude any type of meaningful communication between the members of the audience and the presenter. This loss of control over the audience represents another source of dismay for both the audience members and the presenter.

### BRIEF DESCRIPTION OF THE DRAWINGS

FIG. 1 is a block diagram of a system for content and audience management in a presentation according to an embodiment of the invention.

FIG. 2 is a sample presentation slide used in a system for content and audience management in a presentation according to an embodiment of the invention.

FIG. 3 is a block diagram of a microphone used in a system for content and audience management in a presentation according to an embodiment of the invention.

FIG. 4 is a table showing the levels of relative privilege of various members of the audience according to an embodiment of the invention.

FIG. 5 is a flow chart for a method for presenting content to an audience according to an embodiment of the invention.

FIG. 6 is a flow chart for another method for presenting content to an audience according to an embodiment of the invention.

### DESCRIPTION OF THE EMBODIMENTS

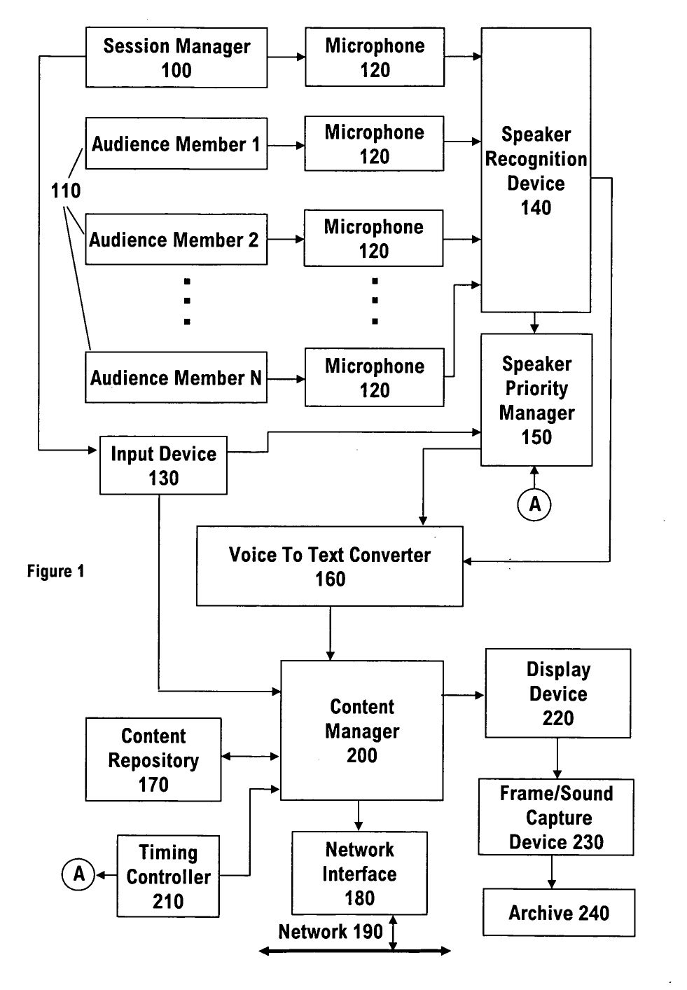

FIG. 1 is a block diagram of a system for content and audience management in a presentation according to an embodiment of the invention. In FIG. 1, session manager 100 represents the presenter or moderator responsible for presenting content to audience members 1 through N, collectively referred to as audience 110. Session manager 100 may make use of input device 130 in order to develop and assemble preplanned content to be presented to the audience members by way of content manager 200. Input device 130 represents one or more input devices such as a keyboard, mouse, trackpad, or other device that controls and directs the operations of content manager 200 by way of a either a wired or wireless communications link. Content manager 200 represents a computer, such as laptop PC, desktop, or other computing resource that controls and formats the content displayed on display device 220.

In the context of the present invention, the term “content” encompasses a broad range of information constructs having meaning to at least some portion of audience 110 or to session manager 100. Thus, content may include predetermined material assembled by the session manager, such as slides that contain bulleted verbal information, bar graphs, charts, and so forth. Content may also include video clips accompanied by audio and other multimedia information. Content may also include any type of information posted on a publicly-available Internet website, or posted to a website available to only individuals within a particular commercial or government enterprise. Finally, content may also include text that corresponds to questions and comments spoken by the session manager or by one or more of members of audience 110. In the embodiment of FIG. 1, these voice inputs are converted to text and presented to audience 110 by way of display device 220.

In the embodiment of FIG. 1, each member of audience 110 has access to one of microphones 120 for conveying voice inputs to speaker recognition device 140, with each one of microphones 120 being associated with a particular one of audience members 1 through N. Each member of audience 110 is assigned a level of relative privilege that determines whether the voice input from the member is to be converted to text and displayed to the audience by way of display device 220. Thus, in one embodiment, a particular audience member signals that he or she wishes to speak by depressing a button on his or her microphone, which causes the microphone to transmit a short preamble or other introductory data segment (perhaps less than 1 second in duration) to speaker recognition device 140. The received preamble causes speaker priority manager 150 to prepare voice-to-text converter 160 to receive the audience member's voice inputs by signaling the voice-to-text converter to load the unique set of voice parameters for the particular audience member so that the incoming voice can be accurately converted to text. The text can then be displayed to audience 110 along with the name of the particular audience member.

It is contemplated that one or more of a variety of wired or wireless interfaces may exist between microphones 120 and speaker recognition device 140. Thus, in some embodiments, each one of microphones 120 is mapped to a unique logical or physical communications channel by which the microphone conveys voice inputs to speaker recognition device 140. Thus, in an embodiment wherein each one of microphones 120 is wired to a particular input channel of speaker recognition device 140, the presence of a signal on the particular input channel may be sufficient for speaker recognition device 140 to determine that a particular member of audience 110 has begun speaking.

In another embodiment, each of microphones 120 transmits bandlimited audio that represents the audience member's voice using frequencies in the range of 300 to 3000 Hz. This allows each microphone to be assigned a unique nonaudible signal (for example, less than 300 Hz or greater than 3000 Hz) that associates the audience member to speaker recognition device 140. The nonaudible signal can be a pure tone or a combination of tones. The unique nonaudible tone accompanies the voice transmission and is therefore present as long as the speaker's microphone continues to transmit.

In another embodiment, speaker recognition device 140 possesses a number of logical addresses, with each logical address being assigned to a particular one of microphones 120. In another embodiment, speaker recognition device 140 analyzes an incoming voice signal and determines the speaker's identity by determining the audience member's Mel Frequency Cepstral Coefficients with an appropriate database. In another embodiment, other attributes of the audience member's voice (e.g. spectrum, frequency range, pitch, cadence, interphoneme pause length, and so forth) are compared a database that contains the attributes of the voices of all of the members of audience 110.

In the embodiment of FIG. 1, speaker priority manager 150 assigns each one of session manager 100 and members of audience 110 is assigned a relative privilege level, in which each member's privilege level can be dynamically modified during the presentation. According to the particular embodiment, there may be various rationales for influencing an audience member's level of relative privilege during a presentation. In one example, the use of relative privilege levels allows the presentation of content from some of members of audience 110 to be deemed more important than content from other members. Accordingly, a particular member of audience 110 whose comments are highly valued during a select portion of the presentation might possess a relative privilege level of 0.95 (on a scale of 0.00 being the lowest relative privilege and 1.00 being the highest). Later in the presentation, the relative privilege of the particular audience member may be reduced as the presentation changes focus, perhaps to a subject area where the audience member's inputs may be less pertinent.

In another example, it may be desirable that each audience member be allowed to add content at least one time during the presentation. In this example, speaker priority manager 150 assigns initially assigns all audience members an equal level of relative privilege. As each audience member adds content, the level of relative privilege of the audience member is reduced so that all of the audience members who have not yet spoken have priority over those members that have spoken. In a variation of this example, the relative priorities of two or more audience members engaged in a healthy debate may have their levels of relative privilege alternately raised and lowered as each member takes a turn to respond to each other's questions or comments.

In another example, a member of audience 110 who has not previously spoken may be assigned a higher level of relative privilege (such as 0.75) until that member has spoken. In the event that the member's questions or comments lose relevance, that member's relative privilege level may be reduced, thus allowing other members of audience 110 to ask questions and provide comments. In another example, in which a presentation is being given to a charitable organization, those members who have recently made donations to the organization are given higher relative privilege than those members who have not made donations. Therefore, in the event that both a donating and non-donating member speaks simultaneously, the donating member's content will be converted to text and presented to audience 110, while the non-donating member's content is not presented until the donating audience member has finished speaking.

In another embodiment, the dynamic reassignment of levels of relative privilege is the result of direct influence by the session manager. For example, in the event that an audience member, who has initially been assigned a high level of relative privilege, becomes unruly or has attempted to steer the presentation in a counterproductive direction, the session manager 100 may manually reduce the audience member's level of relative privilege to preclude the member from adding any type of content.

Session manager 100 retains the highest level of relative privilege throughout the entire presentation, although nothing prevents the dynamic reassignment of the relative privilege of the session manager at one or more times during the presentation. This may be beneficial in those instances where inputs from certain audience members are deemed to be more important than the comments of the session manager, whose role might be more in line with facilitating a discussion among audience members, rather than presenting content.

In the embodiment of FIG. 1, timing controller 210 may be used to influence the relative privilege of the members of audience 110 as well. For example, in the event that session manager 100 has allocated one hour to conduct a portion of a presentation, timing controller 210 may at some point reduce the relative privilege of all members of audience 110 so that the presentation can be completed within the hour. Thus, in the event that content consisting of 30 slides are to be presented during the hour, timing controller 210 could allocate an average of 2 minutes for each slide. In the event that only a few minutes remains in the presentation and significant content has yet to be presented, timing controller 210 may notify speaker priority manager 150 that at least some of audience members 110 should be assigned a reduced level of privilege, thus reducing those audience members' ability to provide content. As the time grows even shorter, timing controller 210 may assert that the relative privilege level of all of audience members 110 be reduced so that session manager 100 can be allowed to present all of the intended content.

In addition to members of audience 110 being allowed to present content in the form of questions and comments that are converted to text and displayed to the audience, a member of audience 110 may also redirect content manager 200 to import content from content repository 170 and an Internet server (not shown) by way of network interface 180. To enable this feature, content manager 200 may include VoiceXML technology (outlined at http://www.w3.org/Voice/Guide/) to permit the audience member to import content from either content repository 170, or from a server interfaced to network 190 by way of network interface 180. Other embodiments of the invention may make use of Speech Application Language Tags (http://www.microsoft.com/speech/evaluation/) to provide the ability to redirect content manager 200. Thus, for example, in event that breaking news is relevant to the presentation, session manager 100 or an audience member having sufficient relative privilege can redirect content manager 200 to import content from an appropriate website. The feature can be invoked by the audience member by merely speaking the URL, or its grammar semantic attachment (for example “google dolphins” is substituted with “http://www.google.com/search?hl=en&ie=UTF-8&oe=UTF-8&q=dolphins”) to display the website at which the content resides.

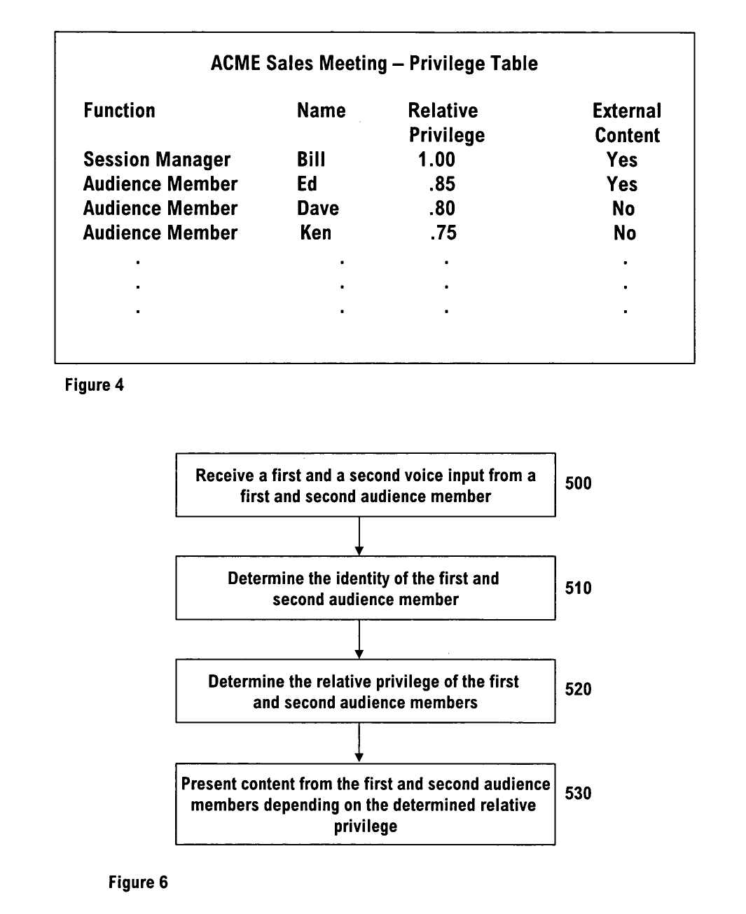

The relative privilege of the various members of audience 110 can also be used to determine those members who can import content versus those who are not allowed to do so (see FIG. 4). Thus, session manager 100 may determine that only the audience members having a relative privilege level of 0.8 or higher may import content from content repository 170 or from network 190.

In a previously mentioned example, as the time allocated for the presentation grows shorter and shorter, the relative privilege of all audience members may be reduced, so that the session manager has sufficient uninterrupted time to complete all of the material in the presentation. In a related example, the ability of the audience to import content from content repository 170 or from network interface 190 may also be affected as the presentation nears the end of the allocated time, thus allowing a particular audience member to quickly add content in the form of a voice input without importing an entire slide, which might take several minutes to discuss.

As the embodiment of FIG. 1 enables the inclusion of preplanned content from content repository 170, content from the Internet, and content that represents an audience member's voice inputs converted to text, frame/sound capture device 230 may occasionally capture a copy of the image displayed by way of display device 220. The captured frame can then be stored by way of archive 240. Archive 240 can be especially useful since the archive provides a record of the additional content added during the presentation. This allows a more comprehensive record of the presentation and allows a person to follow the proceedings far more closely than by merely referring to the original set of presentation slides.

In one embodiment, an archive function is implemented using frame/sound capture device 230 reading picture elements (i.e. pixels) from the memory array within a frame buffer (not shown) of display device 120. These picture elements are transmitted to a data converter (not shown) where the data converter converts the picture elements to a standardized format such as a Joint Photographic Experts Group (JPEG), a graphical interchange format (GIF), or a bitmapped file (BMP). The audio recorded during the presentation can be stored as well. Frame/sound capture device 230 can also be implemented using a digital camera or camcorder, which, under the control of content manager 200, occasionally photographs and archives the image presented by way of display device 220 as well as the accompanying sound files.

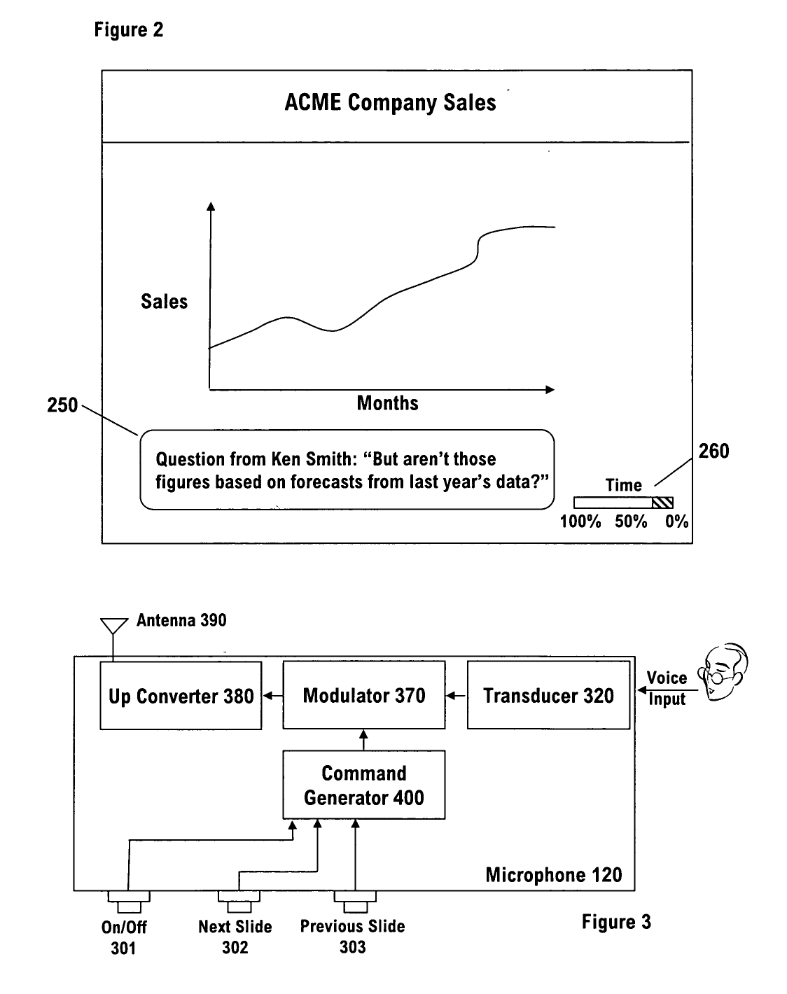

FIG. 2 is a sample presentation slide used in a system for content and audience management in a presentation according to an embodiment of the invention. As shown in the Figure, content in the form of a graph of sales versus months is presented. In a predetermined region of the slide (250) additional content in the form of text converted from a voice input from a particular audience member (Ken Smith) is formatted and presented to the audience. Also shown in the slide is time bar 260 showing the relative amount of time allotted (100, 50, and 0 percent) to complete the presentation.

FIG. 3 is a block diagram of a microphone used in a system for content and audience management in a presentation according to an embodiment of the invention. In FIG. 3, microphone 120 includes transducer 320 that converts the audience member's voice input to an electrical signal. The signal is then conveyed to modulator 370 wherein the signal is converted to the appropriate modulation format (e.g. AM, FM, CDMA, and so forth). Up converter 380 then converts the modulated signal to a carrier so that the signal can be wirelessly transmitted to speaker recognition device 140 (FIG. 1) by way of antenna 390.

The microphone of FIG. 3 also includes “on/off” button 301, which causes command generator 400 to generate a preamble that uniquely identifies the microphone to speaker recognition device 140. The preamble generated by command generator 400 may consist of a numerical code corresponding to a particular audience member, or may include the name of the particular audience member associated with the microphone. It is contemplated that the command generator generates the preamble in less than 1 second, thus allowing the audience member to speak soon after depressing the on/off button.

Microphone 120 additionally includes “next slide” button 302, and “previous slide” button 303. These allow an audience member having sufficient relative privilege to take control of a portion of the presentation. Thus, for example, during a presentation on worldwide sales, several presenters from various sales regions may each wish to present the content that represents the results from each presenter's region. Microphone 120 may also include additional user interfaces for controlling the content and the way in which the content is presented.

In another embodiment, the functions performed by “next slide” button 302 and “previous slide” button 303 are instantiated using by way of voice commands from the audience member in which either of these two commands leads to an immediate interrupt of the voice-to-text conversion process. Additional control commands can also be implemented, thus allowing the session manager or an audience member to jump forward or backward to a particular section of the presentation. For some applications the use of voice commands can bring about a larger command repertoire than would be possible if each command were implemented by way of a discrete button of switch on microphone 120.

FIG. 4 is a table showing the levels of relative privilege of various members of the audience according to an embodiment of the invention. In FIG. 4, the session manager “Bill” is shown as having a relative privilege level of 1.00 and has the ability to import content during the presentation. In the embodiment of FIG. 1, the session manager is contemplated as being a single person with a relative privilege of 1.00 that remains constant throughout the presentation. However, in other embodiments, multiple session managers may be employed with privilege levels being dynamically reassigned to each at various times throughout the presentation. In one such embodiment, a voice command such as “passing control to Ed” is used to convey a change in session managers from Bill to Ed.

In FIG. 4, audience members “Ed”, and “Dave”, and “Jim” are shown as having a relative privilege level of 0.85, 0.8, and 0.75, respectively. As previously discussed herein, these privilege levels may be dynamically reassigned at various times during the presentation. However, at the time during which FIG. 4 pertains, if audience members Ed and Dave were to speak simultaneously, only Ed's voice input would be converted to text and presented to the audience on the display device. Only when Ed has finished speaking can audience members Dave or Jim add content in the way of a voice input.

In another embodiment, a speaker priority manager (150) gradually reduces the privilege levels of the audience member are gradually reduced as the member speaks. Thus, when audience member Ed begins speaking, his level of relative privilege is gradually reduced as time progresses. Thus, as Ed's relative privilege decreases to a level below that of Dave (to 0.75 for example), Dave may be able to interrupt. This provides Ed with some opportunity to add content without allowing Ed to monopolize the presentation.

The table of FIG. 4 also includes a field to indicate whether or not an audience member can import content from a content repository (FIG. 1, 170) or by way of a network interface (180). In some embodiments, only audience members having a higher relative privilege are able to import content, such as in FIG. 4 in which only audience member Ed and session manager Bill are permitted to import content.

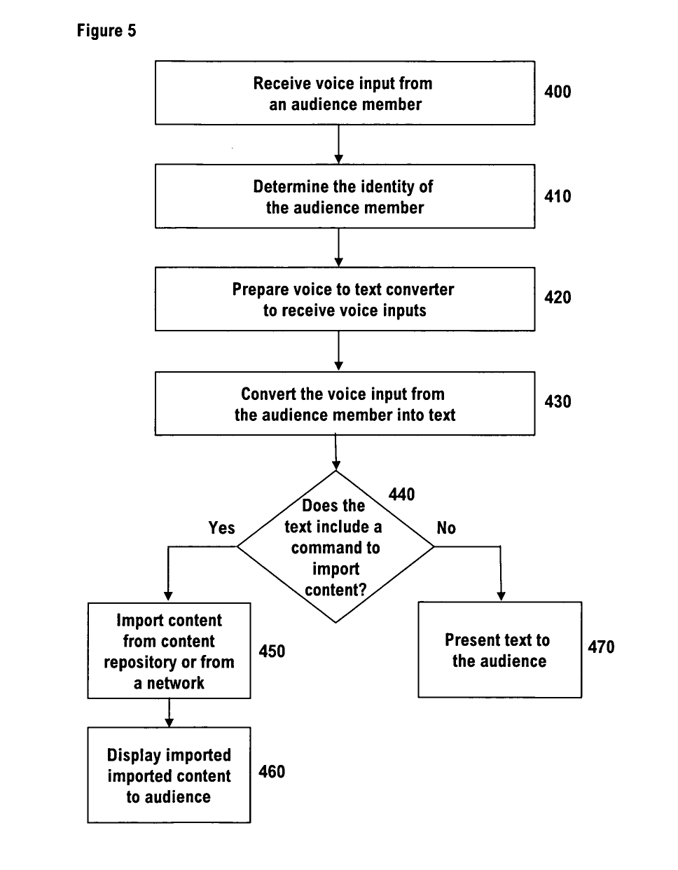

FIG. 5 is a flow chart for a method of presenting content to an audience according to an embodiment of the invention. FIG. 1 is suitable for performing the method of FIG. 5. The method of FIG. 5 begins at step 400 in which a voice input from an audience member is received. The method continues at step 410 in which the identity of the audience member is determined. Step 410 may be accomplished by way of a microphone, which is associated with the audience member, transmitting a preamble to a speaker recognition device. In another embodiment, step 410 is accomplished by way of a speaker recognition device identifying the channel that receives the voice inputs from the audience member. In another embodiment, step 310 may be accomplished by way of a speaker recognition device analyzing one or more attributes of an incoming voice signal and determining the identity of the associated audience member by way of the voice attributes, or by way of determining the Cepstral coefficients of the audience member's voice.

The method of FIG. 5 continues at step 420 in which a voice to text converter (such as an automatic speech recognition engine) is prepared to receive voice input from the audience member. At step 430, the voice input from the audience member is converted to text that corresponds to the voice input. At step 440, a decision is made as to whether or not the text includes a command to import content into the presentation. In the event that content is to be imported, step 450 is executed in which content is imported from a repository or from an external source by way of a network. At step 460, the imported content is displayed to the audience.

In the event that the decision of step 440 indicates that a command to import content is not present in the voice inputs, step 470 is executed in which content in the form of text that corresponds to the received voice inputs is displayed to the audience. In step 470, the content is displayed in a predetermined location of a slide presented to the audience, such as near the bottom of the slide as shown in FIG. 3.

Some embodiments of the invention may include only a few steps of the method of FIG. 5. Thus, a method for presenting content to an audience may include receiving a voice input from an audience member (as in step 400), determining the identity of the audience member (as in step 410), converting the voice input from the identified audience member to text (as in step 430), and presenting the text to the audience (as in step 470).

FIG. 6 is a flow chart for another method of presenting content to an audience according to an embodiment of the invention. The method of FIG. 6 begins at step 500 in which first and second voice inputs from a first and second audience member are received. At step 510, the identity of the first and second audience members is determined. In one embodiment, the determination made in step 510 includes receiving a first and second preamble from each of a first and second microphone associated with the first and second audience members. In another embodiment, step 510 includes receiving voice inputs on a first and second channel, in which each channel is assigned to one of the first and second audience members. In another embodiment, step 510 includes analyzing the attributes, or the Cepstral coefficients of the voice inputs received from the first and second audience members.

The method continues at step 520 in which the relative privilege levels of the first and second audience members are determined. Step 530 is then executed, in which content is presented to the audience from one of the first and second audience members depending on the determined relative privilege of the first and second audience members.

In conclusion, while the present invention has been particularly shown and described with reference to the foregoing preferred and alternative embodiments, those skilled in the art will understand that many variations may be made therein without departing from the spirit and scope of the invention as defined in the following claims. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

1. A method for presenting content to an audience, comprising:
receiving a voice input from an audience member;
determining the identity of the audience member;
converting the voice input from the identified audience member to text;
and presenting the text to the audience.

2. The method of claim 1, wherein the determining step further comprises receiving a preamble from a microphone, the preamble being used to identify the audience member.

3. The method of claim 1, wherein the determining step further includes identifying a nonaudible tone in a signal transmitted from a microphone, the nonaudible tone identifying the audience member.

4. The method of claim 1, wherein the determining step includes identifying the channel through which the voice of the audience member is conveyed.

5. The method of claim 1, wherein the determining step further comprises comparing attributes of the voice of the audience member with stored attributes of the voices of a plurality of audience members.

6. The method of claim 5, wherein the determining step further comprises comparing the audience member's Mel Frequency Cepstral Coefficients with an appropriate database.

7. The method of claim 1, in which the presenting step further comprises displaying the text in a predetermined region of a display that presents the content.

8. The method of claim 1, further comprising the step of displaying a document from the Internet in response to a voice input from the identified audience member.

9. A method for presenting content to an audience during a presentation, comprising:
receiving first and second voice inputs from first and second audience members;
determining the identity of the first and second audience members;
determining the relative privilege of the first and second audience members; and
presenting content to the audience from one of the first and second audience members depending on the determined relative privilege of the first and second audience members.

10. The method of claim 9, wherein the relative privilege of the first and second audience member is influenced by a record of which one of the first and second audience member that last presented content.

11. The method of claim 10, wherein a higher relative privilege is assigned to the one of the first and second audience member audience member that last presented content.

12. The method of claim 10, wherein a lower relative privilege is assigned to the one of the first and second audience member audience member that last presented content.

13. The method of claim 10, wherein the relative privilege is influenced according to which one of the first and second audience members that has not previously presented content during the session.

14. The method of claim 9, wherein the relative privilege is manually reassigned by a session manager.

15. The method of claim 9, wherein the relative privilege of the first audience member is gradually reduced as the first audience member begins providing voice inputs.

16. A system for presenting content, comprising:
a display device for displaying content to an audience;
a content manager for controlling the displayed content, the content manager operating under the control of an audience member; and
a speaker recognition device for determining the identity of an audience member controlling the content manager.

17. The system of claim 16, further comprising a voice to text converter coupled to the speaker recognition device that converts voice inputs from the audience member into text and for conveying the text to the content manager.

18. The system of claim 16, wherein the content manager receives the text and formats the text for display by the display device.

19. The system of claim 16, wherein the content manager formats the text for display in a predetermined region of a slide presented by way of the display device.

20. The system of claim 16, wherein the speaker recognition device receives a preamble from at least one microphone associated with the audience member.

21. The system of claim 16, wherein the speaker recognition device monitors a plurality of input channels through which the voice inputs from the audience member is conveyed.

22. The system of claim 16, wherein the speaker recognition device compares attributes of the voice of the audience member with stored attributes of a plurality the voices of the audience members.

23. The system of claim 16, wherein the speaker recognition device determines the Mel Frequency Cepstral coefficients of the audience member's voice.

24. The system of claim 16, wherein the speaker recognition device receives a nonaudible tone from at least one microphone associated with the audience member to determine the identity of the at least one audience member.

25. The system of claim 16, wherein the content manager is redirected under the control of the audience member.

26. The system of claim 16, wherein the content manager further comprises a connection to the Internet for importing content from the Internet for display by the display device.

27. The system of claim 16, wherein the content manager, in response to receiving voice inputs from a plurality of audience members, formats for display on the display device only the text corresponding to the audience member having the highest relative privilege.

28. The system of claim 16, additionally comprising a timing device coupled to the content manager, wherein, in response to a first timing signal, the content manager displays text only from audience members having a first relative level of privilege.

29. The system of claim 28, wherein, in response to a second timing signal, the content manager displays text only from audience members having a second relative level of privilege.

30. The system of claim 16, further comprising a frame capture device coupled to the display device for occasionally capturing and storing an image of the content displayed by the display device.

31. A system for presenting content to an audience, comprising:
means for presenting content to an audience;
means for receiving voice commands from a plurality of audience members;
means for determining the relative privilege levels of the plurality of audience members; and
means for selecting the presented content in response to the voice commands and the privilege levels that correspond to each of the plurality of the audience members.

32. The system of claim 31, wherein the means for receiving voice commands from the plurality of audience members includes means for receiving voice inputs from a plurality of microphones.

33. The system of claim 31, wherein the means for receiving the voice inputs from the plurality of microphones includes means for receiving a nonaudible tone from at least one of the plurality of microphones.

34. The system of claim 31, further comprising means for determining the time remaining in the presentation, the means for determining the time remaining in the presentation being used to limit the content selected for presenting to the audience by the means for selecting the projected content.

35. The system of claim 31, additionally comprising means for storing a record of the presented content, wherein the presented content includes voice inputs from the audience and imported content.
